(19) United States
(12) Patent Application Publication
(10) Pub. No.: US 2003/0160170 A1
(43) Pub. Date: Aug. 28, 2003

(54) Methods and apparatus for atomic force microscopy

(76) Inventors: Terence J. McMaster, Clifton Bristol Avon (GB); Mervyn J. Miles, Bristol Avon (GB); Massimo It, Clifton Bristol Avon (GB); Andrew D. L. Humphris, Bristol Avon (GB)

Correspondence Address: LARSON & TAYLOR, PLC, 1199 NORTH FAIRFAX STREET, SUITE 900, ALEXANDRIA, VA, 22314, US

(21) Appl. No.: 10/240,259

(22) PCT Filed: Mar. 30, 2001
(86) PCT No.: PCT/GB01/01470

(51) Int. Cl. G21K 7/00; G01N 23/00

(52) U.S. Cl. 250/306; 250/307

(57) ABSTRACT

A probe module for atomic force microscopy has a substrate (33) and a deflectable cantilever probe (4) projecting from it. In the head of the atomic force microscope the probe is mounted with its axis perpendicular to the sample surface, e.g. so as to carry out shear force microscopy or transverse dynamic force microscopy. The cantilever probe (4) has a reflective surface (43) which is directed back up along the probe so that movement of the probe tip can be tracked using a light beam arrangement which in itself may be conventional. By this means, AFM procedures in perpendicular modes can be carried out using AFM heads requiring little modification from the conventional near-parallel mode arrangement. The probe may also be used in tapping mode to investigate sidewall features on a sample surface.

### FIELD OF THE INVENTION

This invention has to do with methods and apparatus for atomic force microscopy (“AFM”), and in particular to new arrangements and modes of use for cantilever probes in atomic force microscopes.

### BACKGROUND OF THE INVENTION

Atomic force microscopes image the surface of the sample by means of a minute cantilever probe with a sharp tip which is brought into extreme proximity, and sometimes contact, with the sample surface. The interaction between sample and probe is observable by monitoring the deflection of the cantilever as the latter is scanned over the sample surface. The cantilever probes are very delicate and sensitive objects, typically projecting one or two hundred μm from a chip substrate on which they are created by microfabrication techniques such as etching. Usual materials are silicon and silicon nitride.

### PRIOR ART

One conventional AFM head arrangement in shown in FIG. 1. An arch-shaped optical head block 1 is mounted over a sample support arrangement including a sample stage 21. A sample for investigation is positioned on the sample stage 21 and can be moved (scanned) relative to the optical head by means of coarse adjustment screws 22 and a piezoelectric scanning drive of a known kind, not shown. A probe holder 3, here in the form of a flat metal locating plate, fits into the arch of the optical head block 1 over the sample stage 21. The chip substrate 33 carrying the cantilever probe is mounted to the probe holder 3. This may be mounted on a piezoelectric element (not shown) or other suitable means by which a driving force on the cantilever probe can be applied. In this set-up the probe is fixed (in the XY plane) in use, scanning being by XY movements of the sample stage 21. Other forms of AFM apparatus exist which scan the probe holder rather than the sample.

The conventional disposition of the cantilever probe relative to the sample/sample stage is shown in FIG. 2. The cantilever 4 is a straight, flat silicon nitride projection with a downwardly-directed pyramidal or conical point 41 at its end, perhaps 5 μm deep. The chip substrate 33 is mounted to bring the probe 4 as near parallel to the sample surface/sample platform as the necessary clearance for the holder and chip substrate permits; usually this involves about a 10° tilt from horizontal. The thickness of the cantilever perpendicular to the sample is usually only about 0.5 μm and it undergoes significant deflections under very small forces. The angular orientation of the cantilever probe 4 is observed via a so-called optical lever arrangement. The top surface of the cantilever 4 is made reflective—e.g. by deposition of a gold layer—and a laser beam from a laser 5 mounted in the optical head is trained on this reflection surface, to reflect away over a distance of a few cm to a segmented photodetector 6.

Because of the long optical travel, minute angular movements of the probe tip cause substantial movements of the light beam across the photodetector 6. The photodetector is sensitive to changes in the relative intensity of light incident on its respective segments. The difference between the outputs from different segments is used to observe the deflection of the cantilever probe.

There are various ways of operating the probe to scan a sample, including contact modes, non-contact modes and tapping modes in which the probe driver is used to move the probe up and down into and out of contact with the surface.

### THE INVENTION

We are particularly interested in developing low-force non-contact modes, and in finding dynamic techniques facilitating the elucidation of elastic and dissipative force components in the probe's interaction with a sample surface.

As part of these researches we have arrived at a new way of arranging a cantilever probe in an AFM system which may be otherwise-conventional. What we propose is firstly that the probe axis direction is arranged substantially perpendicular to the sample presentation plane, the probe driver then being operable to move the probe tip across the sample surface rather than towards and away from it. This in itself is known. Secondly, the probe has a reflection surface for directing an incident light beam towards a detector and a normal of the reflection surface has a rearward component back along the probe axis, away from the sample in use. In this arrangement the incident beam of a beam-reflection position detector system can approach the sample stage and be reflected back away from it, e.g. as in the optical pathway of known arrangements using a horizontal cantilever.

The rearwardly-directed reflection surface may be inclined e.g. at an angle of at least 30° from the probe axis. Typically it is formed to act as a planar mirror.

A cantilever probe having a reflection surface so oriented relative to the probe axis is an independent aspect of the invention. Another independent aspect is a probe holder carrying a cantilever probe with its probe axis extending substantially perpendicularly to a sample presentation plane and with the probe having a reflection surface with a normal directed back i.e. having a rearward component relative to the probe axis, as proposed herein.

The cantilever preferably.,incorporates the. reflection surface on an integral rearwardly-directed surface portion, e.g. on a laterally projecting portion. A projection can routinely be formed by microfabrication techniques such as etching; in this case the rearwardly-directed reflection surface is conveniently oblique although it may be perpendicular to the probe axis direction. Such a lateral projection may be formed in a similar way, and indeed in a similar shape, to the pyramidal projections which in conventional cantilevers are used as the sharp probe tip. The reflection surface may be given a reflective coating e.g. of gold or aluminium.

The fine probe tip itself, shaped for interaction with the sample surface, is generally positioned forward of the reflection surface. In most cases it is at the distal extreme of the cantilever probe, although for certain special uses it may be laterally directed relative to the cantilever axis. This is described later. The probe tip can be provided as a sharp formation on the main shaft of the cantilever, e.g. a whisker.

The novel disposition of the reflection beam relative to the cantilever axis in the present proposal can be associated with advantageous modes of microscopic investigation of a sample. The cantilever probe can be presented to a sample surface essentially perpendicularly. The probe can then be oscillated laterally across the sample surface and the resulting movements of the probe tip detected by the observation of the reflected beam. This provides a new and convenient way of carrying out shear force microscopy (ShFM) or transverse dynamic force microscopy (TDFM) exploiting reflected-beam detection methods/apparatus which in themselves are conventional and familiar to a skilled person.

Indeed, a particular option in the present proposals is the ability to modify an existing AFM optical head, which already includes means for projecting a beam onto a (conventional) cantilever arrangement and directing the reflected beam onto a suitable position-sensitive detector such as a segmented photodiode. A cantilever arrangement according to the present proposal, i.e. with a perpendicularly-oriented cantilever having a rearwardly-directed reflection surface, can be substituted for the conventional cantilever and the existing optical detection system exploited substantially unchanged. The range of investigative techniques available with that microscope system is therefore significantly enhanced.

A particular novel mode of use proposed herein, exploiting substantial perpendicularity of the cantilever probe to the sample surface, is the ability to insert the probe tip into depressions of a sample surface, e.g. in close proximity to an upright feature such as a sidewall on an integrated circuit construction or to an undercut feature. Conventional cantilever set-ups cannot access such steep formations. For this purpose, the cantilever probe of the invention may be used with a probe tip directed axially, as the extreme end of the probe, and/or directed laterally so that the probe can be used against a steep surface beside it e.g. in a tapping mode.

Another advantageous feature of a microscope operating with the cantilever perpendicular to the sample surface (for TDFM) is the availability of true probe tip-sample surface distance control. The spring constant along the cantilever axis is much higher than the spring constant for lateral bending. In conventional AFMs with a cantilever generally parallel to the sample the degree of bend relates directly to both the tip-sample separation and the monitored force at the tip, so these cannot be independently determined. In a perpendicular TDFM or ShFM cantilever the degree of bend scarcely affects the tip-sample separation, which can be therefore be set effectively independently by axial adjustment of the probe. This offers significant advantages for TDFM over conventional AFM, in particular for force displacement experiments. These involve extending or compressing an entity retained between the tip and the sample surface, measuring force as a function of tip-sample separation. An example is single-molecule force spectroscopy, when the entity between the tip and surface is a single molecule whose structural behaviour is under investigation. As a dynamic technique TDFM enables measurement of conservative and dissipative interactions. These extra functions become available if a conventional optical lever AFM system is modified to an optical lever TDFM by means of the present proposals.

The invention is now described with reference to the following drawings.

### BRIEF DESCRIPTION OF THE DRAWINGS

In the drawings,

FIG. 1 is a perspective schematic view of a known AFM head arrangement;

FIG. 2 is a schematic view of the cantilever probe disposition in the conventional AFM head arrangement;

FIG. 3 shows a cantilever probe arrangement in accordance with our invention;

FIGS. 4(a), (b), (c) show different cantilever probe shapes, and the disposition of probes on a chip substrate;

FIGS. 5 and 6 show two arrangements of a cantilever probe holder embodying our proposals, and

FIGS. 7 and 8 show the tips of cantilever probes operating according to a variant procedure.

### DETAILED DESCRIPTION OF PREFERRED EMBODIMENTS

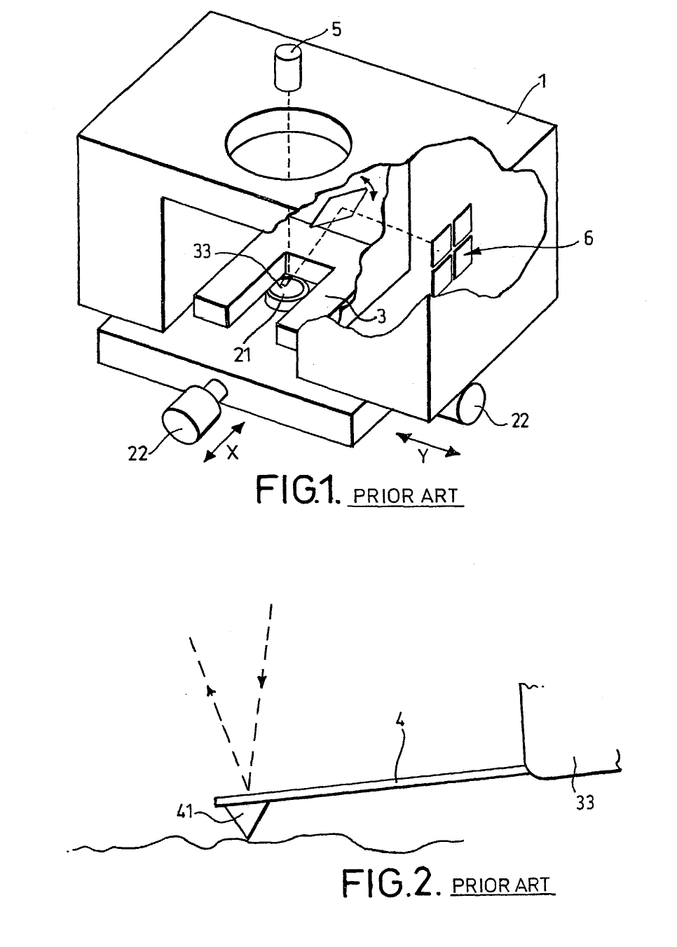

FIGS. 1 and 2 have already been described and relate to prior art.

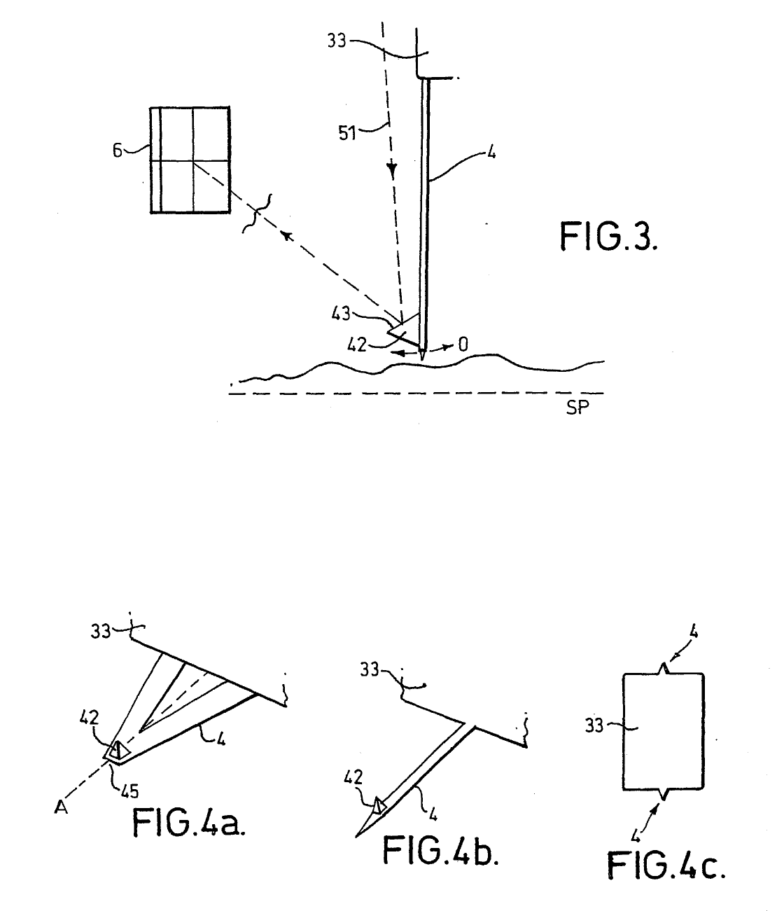

FIG. 3 shows a cantilever probe with its probe axis arranged perpendicular to the sample plane SP, in accordance with our new proposal. Near the tip of the probe a lateral projection 42 is formed by etching/deposition. In this version it is made similarly to the contact points on conventional probes, i.e. as a generally pyramidal formation with a flat rearwardly-directed oblique face 43. It need not have a sharp tip, however. A gold coating is deposited on the oblique face 43 for function as a reflection surface. The angle which the reflection surface 43 makes with the probe axis is not critical insofar as detection of probe movements is concerned, but is significant in providing for a convenient disposition of the sources, reflectors and detectors for the incident and reflected beams 51 of the optical system which is used for that detection. The present embodiment has the incident laser beam 51 substantially perpendicular to the sample plane SP and reflecting away obliquely to the detection arrangement with its four-quadrant photodetector 6, i.e. as in the conventional module seen in FIG. 1.

In operation, the cantilever probe 4 makes oscillations substantially parallel to the sample plane by means of a piezoelectric driver, oscillating magnetic field or other suitable means. These drives may be applied to the chip substrate 33 from which the cantilever probe 4 is mounted, in a manner which is itself conventional. Alternatively drive may be via a magnetic field applied to the cantilever directly, or via acoustic coupling through a liquid.

In this construction the pyramid projection 42 functions only to carry the reflection surface. The probe tip itself—which may comprise a fine probe extension 45—is at the extreme distal end of the probe and is oscillated in close proximity to the sample surface so as for example to carry out shear force or transverse dynamic force microscopy. The present technique using a single deflected beam in this novel arrangement is simple to use and furthermore can be implemented in apparatus which may in other respects be conventional.

FIG. 4(a) shows that the probe 4 may take the form of a flat V bisected by the probe axis A, with the reflector projection formed near the tip. Such a construction is typically of silicon nitride. FIG. 4(b) shows an essentially linear probe e.g. of silicon. These general forms are known, but in the present embodiment the tip of the pyramid projection need not be refined for interaction with the sample; on the contrary the pyramid or other-shaped lateral projection can be blunt and may be made relatively large for its new role as a reflection surface. By contrast the axially-directed tip of the probe is made with a fine point or whisker for interaction with the sample surface.

FIG. 4(c) shows how more than one probe 4, e.g. of different shapes, sizes or spring constant, may be formed on a single substrate chip 33. Again, this is known in itself.

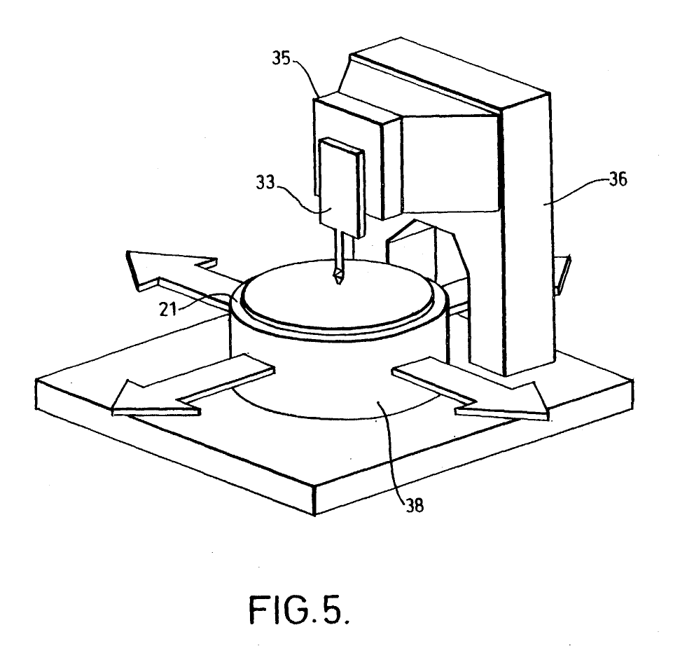

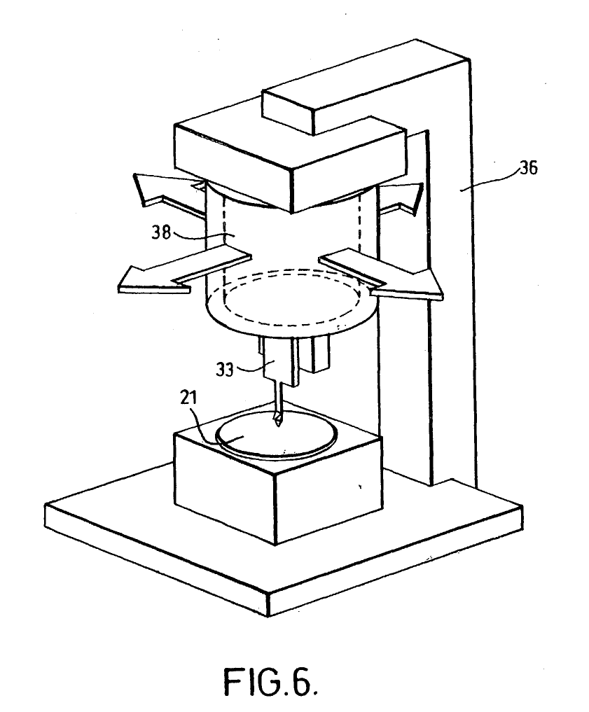

FIG. 5 shows a cantilever probe holder 3 in accordance with one aspect of the present invention, designed for substitution for the conventional probe holder of a known AFM optical head e.g. as seen in FIG. 1. The cantilever probe chip substrate 33 is mounted, e.g. via an insulated piezoelectric driver pad 35, on a mounting 36 so that the probe axis is directed down onto the area on the sample platform 21. In fact it need not be exactly orthogonal in relation to the surrounding microscope construction. Particularly when modifying existing apparatus a slight angle may be preferable because it reduces possible difficulties of obstruction of the incident laser beam. Since conventional sample supports provide for the possibility of slightly inclining a supported sample, there is no problem in achieving an operating set-up with the actual sample presentation plane truly perpendicular to the probe axis.

This embodiment is a scanned-sample type in which a piezoelectrically-drivable scanning module 38 carries the sample platform 21. FIG. 6 shows an alternative mounting of the scanned-tip type, with the piezoelectric scanning drive 38 carying the probe chip 33 and the sample platform 21 static. Here the incident laser may need to be brought in at an inclination, i.e. non-vertically.

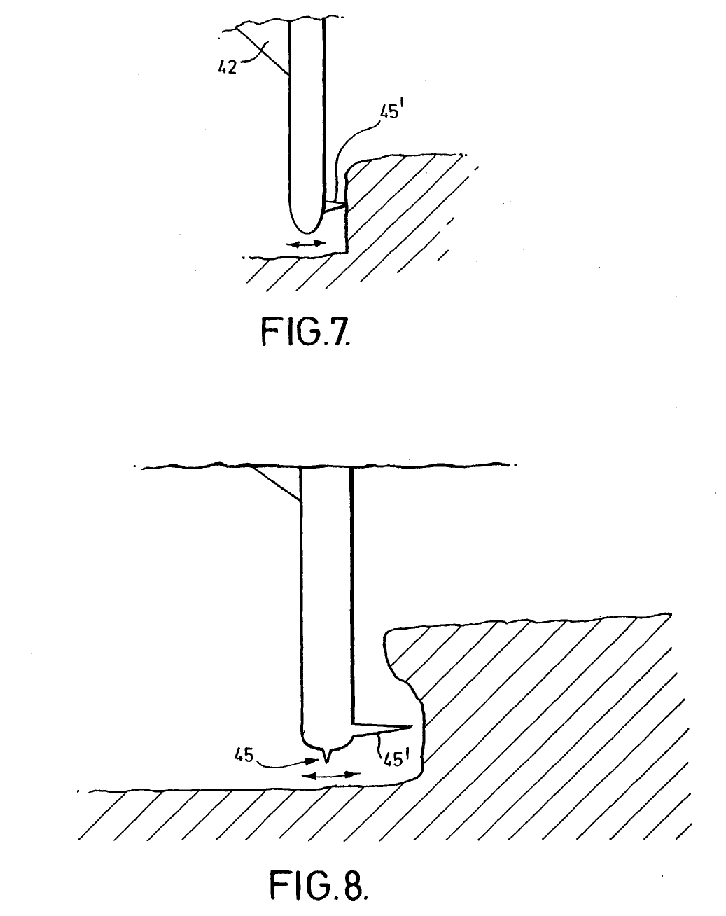

FIG. 7 shows (more greatly enlarged) a variant mode of operation in which a probe whisker tip 45′ is laterally-directed at the probe end. This enables the investigation, e.g. by tapping mode microscopy, of sample surface portions which are steeply inclined or vertical or are next to such features, e.g. trenches or walls in etched semi-conductor products. Conventional AFM arrangements cannot access such surfaces at all.

FIG. 8 shows a different variant where the sample surface is actually undercut. It also shows that the probe may combine a laterally-directed tip 45′ with a longitudinally-directed tip 45.

1. A probe module for atomic force microscopy comprising a substrate (33) and a deflectable cantilever probe (4) which projects forwardly in a probe axis direction from an integral join with the substrate to a free end, the cantilever probe (4) having
a probe tip (45) adjacent to the free end for interaction with a sample surface in use, and
a reflection surface (43) which is spaced along the cantilever probe (4) away from its integral join with the substrate (33) and which in use serves to reflect an incident light beam to a detector, to indicate the positional behaviour of the probe tip (45). characterised in that
the reflection surface (43) is inclined to the probe axis such that a normal of the reflection surface (43) has a rearward component, back along the probe axis.

2. A probe module according to claim 1 in which the normal of the reflection surface (43) is inclined rearwardly at at least 30° from a perpendicular to the probe axis.

3. A probe module according to claim 1 or claim 2 in which the reflection surface (43) is oblique to the probe axis.

4. A probe module according to any one of claims 1 to 3 in which a said probe tip (45) is formed on the probe forwardly of the reflection surface (43).

5. A probe module according to any one of the preceding claims which a said probe tip (45) is at the free end of the cantilever probe (4) and points forwardly in the probe axis direction.

6. A probe module according to any one of the preceding claims in which a said probe tip (45′) projects laterally from the cantilever probe (4) adjacent its free end.

7. A probe module according to any one of the preceding claims in which the reflection surface (43) is a rear surface on a lateral projection (42) from the cantilever probe (4).

8. A probe module according to any one of the preceding claims in which the reflection surface (43) is flat or substantially flat.

9. A probe module according to any one of the preceding claims in which the reflection surface (43) has a reflective coating.

10. A probe module to according to any one of the preceding claims in which the cantilever probe (4) is a microfabricated formation on the substrate (33), the substrate being a semiconductor chip.

11. A method of performing atomic force microscopy comprising
mounting a sample in atomic force microscope apparatus comprising a probe module according to any one of claims 1 to 10;
bringing a surface of the sample and the probe tip (45) of the probe module into proximity, with the probe axis of the probe module substantially perpendicular to said sample surface;
driving a relative movement between the probe tip (45) and sample surface in one or more directions across the sample surface, and
tracking the positional behaviour of the probe tip (45) by directing a light beam (51) at the reflection surface (43) of the cantilever probe (4) and detecting the reflected beam.

12. A method according to claim 11 in which the relative movement is oscillatory.

13. A method according to claim 11 or 12 in which the cantilever probe (4) has a laterally projecting probe tip (45′) according with claim 6, the sample surface has a shape feature with an upstanding sidewall, such as a depression or step, the laterally projecting probe tip (45′) and the side wall are brought into proximity and in said driven relative movement moved towards and away from one another in a direction transverse to the probe axis.

14. An atomic force microscope head structure comprising a probe mount (36) and a probe module according to any one of claims 1 to 10 mounted via its substrate (33) to the probe mount (36).

15. An atomic force microscope head structure according to claim 14 defining a sample presentation area, the probe axis of the cantilever probe (4) of the probe module being arranged substantially perpendicularly to the sample presentation area.

16. An atomic force microscope head structure according to claim 15 comprising a sample platform (21) at the sample presentation area, the probe axis of the cantilever probe (4) being substantially perpendicular to the surface of the sample platform (21).

17. An atomic force microscope head structure according to any one of claims 14 to 16 further comprising a detector system having a light source to direct an incident light beam onto the reflection surface (43) of the cantilever probe (4), in a direction which is forward in relation to the probe axis and preferably substantially parallel thereto, and a light detector to detect the reflected beam from said reflection surface (43).

18. An atomic force microscope having a microscope head structure according to any one of claims 14 to 17.

19. A method of modifying an atomic force microscope which has a head-structure including a sample platform, a probe mount for mounting a probe module adjacent to a sample on the sample platform and a detection system including a light source to direct an incident light beam towards the sample platform, preferably substantially perpendicularly thereto, and a light detector to detect reflected light derived from the incident light beam,
the method of modifying the atomic force microscope comprising replacing said probe mount of the atomic force microscope's head structure with a probe mount (36) and probe module according with any one of claims 14, 15 and 16.
